(19) United States
(12) Patent Application Publication
(10) Pub. No.: US 2026/0330280 A1
(43) Pub. Date: Oct. 22, 2026

(54) ERROR CHARACTERIZATION USING AI-BASED PREDICTIONS FROM PHASE-IN/OUT CONTROLS

(71) Applicant: Dell Products L.P., Round Rock, TX (US)

(72) Inventors: Brendan Burns Healy, Haddonfield, NJ (US); Tejinder Singh, Manotick (CA); Navjot Kaur Khaira, Manotick (CA); Rômulo Teixeira de Abreu Pinho, Niterói (BR)

(21) Appl. No.: 19/181,192

(22) Filed: Apr. 16, 2025

(51) Int. Cl. G06N 10/40; G06N 7/01

(52) U.S. Cl. CPC G06N 10/40; G06N 7/01

(57) ABSTRACT

One example method includes, for a quantum job that has been submitted to a quantum device, running a background process comprising applying a respective phase-in control signal to each qubit line of the quantum device, reading respective phase-out signals at an output of each of the qubit lines, concatenating the phase-in signals with a directed acyclic graph (DAG) of the quantum device to create a model input, and providing the model input to a ML (machine learning) model and obtaining, from the ML model, an estimate of a noise characteristic of the quantum device while the quantum job is executing on the quantum device.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to quantum computing systems and processes. More particularly, at least some embodiments relate to systems, hardware, software, computer-readable media, and methods, for error characterization using AI-based predictions from phase-in/out controls.

### BACKGROUND

Noise in quantum systems affects circuit execution and make results less reliable. However, noise quantification information can become obsolete quickly because noise constantly pollutes the quantum system. Moreover, calibration procedures are costly and leave quantum systems out of operation for long times, such that re-running calibration processes often to update noise quantification information is impractical. Finally, job execution decisions may be erroneous when calibration data is obsolete.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture, according to one embodiment.

FIG. 2 discloses aspects of a method, according to one embodiment.

FIG. 3 discloses an example computing entity configured and operable to perform any of the disclosed methods, processes, and operations.

### DETAILED DESCRIPTION OF SOME EXAMPLE EMBODIMENTS

Embodiments disclosed herein generally relate to quantum computing systems and processes. More particularly, at least some embodiments relate to systems, hardware, software, computer-readable media, and methods, for error characterization of quantum circuits and quantum devices using AI-based (artificial intelligence-based) predictions from phase-in/out controls.

Example embodiments comprise, but are not limited to, methods for error characterization in a quantum device. One or more particular embodiments may employ AI-based error predictions based on phase-in/out controls applied to qubits of a quantum device such as a QPU (quantum processing unit).

One example embodiment of a method comprises operations including, but not limited to: for a quantum job submitted to a quantum device, running a background process comprising application of a phase-in control signal to each qubit line of the quantum device; reading a phase-out signal at an output of the quantum job; concatenating the phase-in and phase-out signals with a coupling map directed acyclic graph (DAG) of the quantum device to create a model input; and, feeding the model input to a model to obtain an estimate of a noise characteristic of the quantum device.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may determine aspects of a quantum system noise characterization. An embodiment may employ noise characteristics of a quantum system to processes including transpilation, assessing validity of algorithm results, and application of error mitigation mechanisms. An embodiment may characterize noise present in a quantum device at job execution time. An embodiment may enable implementation of noise mitigation processes based on noise characteristics. Various other advantages of one or more example embodiments will be apparent from this disclosure.

### A. REFERENCES

Reference is made herein to various documents, which are listed below. These documents are incorporated herein in their respective entireties by this reference.
[1] https://docs.quantum.ibm.com/admin/calibration-jobs
[2] IBM Qiskit https://docs.quantum.ibm.com/api/qiskit/quantum_info#gate_error

### B. OVERVIEW OF ASPECTS OF ONE OR MORE EMBODIMENTS

Noise in quantum systems affects circuit execution and make results of the execution less reliable. Calibration procedures help characterize the noise in the system. This characterization is useful in, for example, pre-processing tasks such as transpilation, assessing the validity of algorithm results, post-processing tasks such as applying error mitigation mechanisms. See [1].

Further, obtaining up to date noise characteristics at quantum job execution time, that is, in real time as the job is executing, gives developers and system administrators a chance of predicting how noise will affect each job submission. In one analogous approach, a qubit may be replicated at circuit level to help obtain more qubit measurements with fewer quantum shots. In an embodiment, a similar replication can be made at the hardware level, using phase signals, to help detect errors on individual qubit lines. Thus, one example embodiment comprises an AI/ML mechanism, such as a model, by which aspects of a quantum system noise characterization can be inferred from measuring phase differences on qubit wires.

### C. DETAILED DISCUSSION

### C.1 Architecture

One or more embodiments may comprise methods implemented in connection with architectures that comprise a quantum system or device, such as a QPU for example, that comprises one or more qubits. In an embodiment, a method is implemented by classical computing resources that may comprise hardware and/or software. Other embodiments may be implemented by quantum computing hardware, or a combination of classical and quantum computing resources that may comprise hardware and/or software.

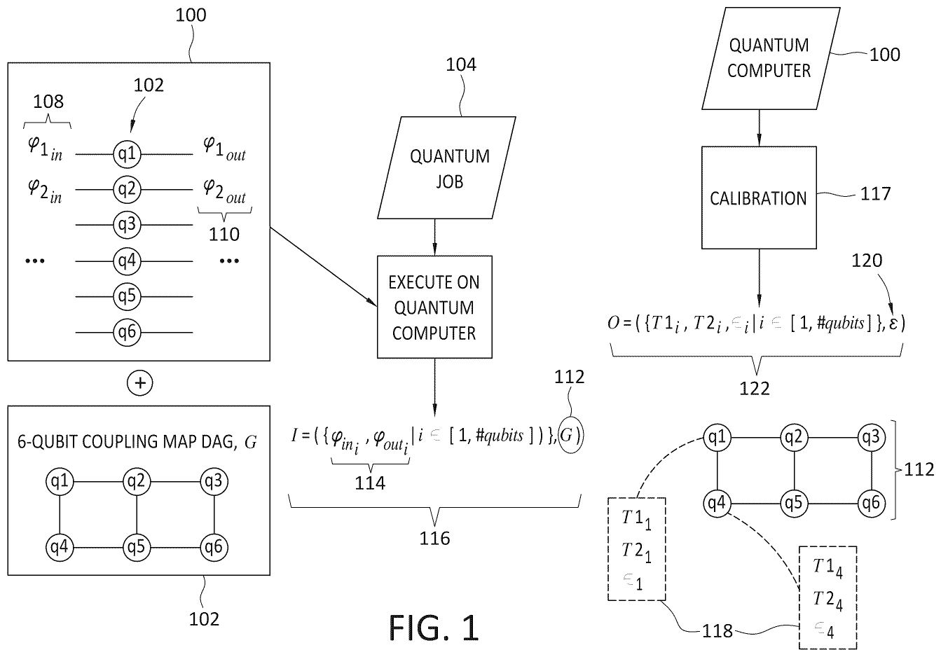

With reference now to FIG. 1, a simplified depiction of a QPU 100 according to an embodiment is disclosed. In this example, the QPU 100 may comprise qubits 102. A quantum job 104 provided to the QPU 100 may be executed by the qubits 102 and may result in generation of noise during that execution. As shown, each of the qubits 102 may generate a respective output, one or more of which may include noise due to various causes. For example, such noise may be generated during execution of the quantum job 104 due to the structure and/or operation of the qubit 102, and/or due to aspects of the quantum job 104 itself.

As discussed in more detail below, in an embodiment, a phase-in control signal 108 may be applied to each of the qubit line(s) for the qubits 102. A respective corresponding phase-out signal 110 may be measured at the outputs of the qubit lines for the qubits 102. The phase-in control signal(s) 108 and phase-out signals 110 may be concatenated with a directed acyclic graph (DAG) 112, or other representation, that comprises a qubit coupling map of the QPU 100, and, as discussed below, the resulting concatenation supplied as an input to an ML (machine learning) model. The ML model may then perform an inferencing process to obtain an estimate of the noise characteristics of the QPU 100.

### C.2 Example Embodiment of a Calibration Process

With continued reference to the example of FIG. 1, a method according to one embodiment may apply a phase-in/out control mechanism, such as the phase-in control signal 108, to every qubit line of a given quantum device such as the QPU 100. For every quantum job 104 submitted to the quantum device 100, a process is run in the background in which a phase is applied to each qubit line and read out at the quantum job 104 output. In this way, a phase pair {φᵢₙ_{ᵢ}, φₒᵤₜ_{ᵢ}} 114 is obtained for each qubit q; 102.

The phase pair 114 may then be concatenated with a directed acyclic graph (DAG) 112 of the quantum device 100 coupling map which indicates which pairs of qubits support two-qubit operations between them. This concatenation forms an input tuple, I=({φᵢₙ_{ᵢ}, φₒᵤₜ_{ᵢ}|i∈[1, #qubits])}, G) 116, where φ are the per-qubit phases and G is the DAG.

When a calibration process 117 is executed, or to be executed, with respect to the QPU 100, the following parameters may be obtained about qubits 102 and gates of the QPU 100:
[a] coherence times T1/T2, and measurement error rates ϵ (collectively indicated at 118 in FIG. 1) of each qubit 102; and
[b] average gate error ¿ 120 of the quantum device 100.

As shown in FIG. 1, these parameters may be concatenated into an output tuple O=({T1ᵢ, T2ᵢ, ϵᵢ|i∈[1, #qubits]}, ε) 122.

Thus, the input tuple comprises the inputs that are used by a calibration process to generate the various parameters that make up the output tuple. The output tuple may be used by a machine learning (ML) model M_{θ}, an example of which is discussed below, to generate an estimate of the noise characteristics of the QPU or other quantum device that was the subject of the calibration process.

### C.3 Training for an Embodiment of a Noise Characterization ML Model

As noted above, one or more embodiments may comprise a machine learning model that may be trained to generate noise characteristics estimates for a quantum device. The ML model may be trained using a training dataset constructed as discussed below.

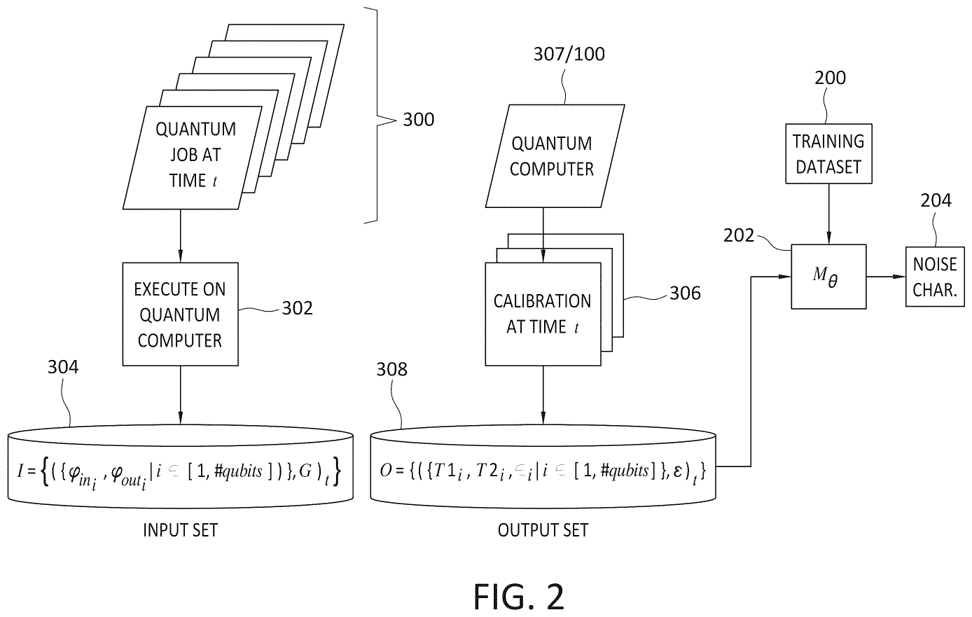

For example, and with reference now to FIG. 2, a large training dataset 200 with N samples {Iᵢ, Oᵢ} |i∈[1, N] may be built by executing N quantum jobs, on the quantum hardware of interest for example, to obtain Iᵢ and associating Iᵢ with the latest calibration data available Oᵢ. In an embodiment, a subset of samples may be executed prior to a new round of calibration to induce variability in Oᵢ. This training dataset may then be used to train a machine learning model M_{θ} 202.

In particular, the machine learning model M_{θ} 202, with parameters θ may be trained to learn an optimal mapping Ô=M_{θ*}(I) from the training dataset 200, where

$${θ}^{*} = {arg min}_{θ} Err ( O , \hat{O} )$$

and Err measures the aggregate difference between the estimated Ô and the true O associated with I.

### C.4 Operational Aspects of an Embodiment

Upon a new job 300 submission to a quantum device, and execution 302 of the job 300 on the quantum device, the job orchestration process adds the phase-in control signals on each qubit line to define an input set 304. The input set 304 can be used by a calibration process 306 performed on a quantum device 307 to generate a set of a phase-out read outs, that is, an output set 308, that can be concatenated with a coupling map DAG, such as the DAG 112 for example, of the device and fed to the trained model M_{θ*} 202 to obtain an estimate of the quantum noise characteristics 204.

### D. FURTHER DISCUSSION

As disclosed herein, example embodiments may comprise various useful features and aspects, although no embodiment is required to possess any of such features or aspects. The following examples are illustrative, but not exhaustive.

One embodiment comprises a predictive mechanism that efficiently characterizes the noise present in a quantum device at job execution time. An embodiment comprises a mechanism by which the noise characteristics of a quantum device are inferred from phase-in/out controls associated with every qubit line of the quantum device and their relationship with the device topology, as defined by its qubit coupling map in the form of a DAG. An embodiment may comprise a data collection mechanism by which a training set containing the described {input, output} pairs is obtained by a process running in the background, without affecting job submissions. By way of contrast with these examples, convention approaches lack a mechanism, such as the addition of phase in/out controls added to the qubit lines, by which real-time estimates noise in a quantum system can be quickly obtained via machine learning. In particular.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence now other than the specific sequence recited.

### F. FURTHER EXAMPLE EMBODIMENTS

Following are some further example embodiments. These are presented only by way of example and are not intended to limit the scope of this disclosure or the claims in any way.

Embodiment 1. A method, comprising: A method, comprising: for a quantum job that has been submitted to a quantum device, running a background process comprising applying a respective phase-in control signal to each qubit line of the quantum device; reading respective phase-out signals at an output of each of the qubit lines; concatenating the phase-in signals with a directed acyclic graph (DAG) of the quantum device to create a model input; and providing the model input to a ML (machine learning) model and obtaining, from the ML model, an estimate of a noise characteristic of the quantum device while the quantum job is executing on the quantum device.

Embodiment 2. The method as recited in any preceding embodiment, wherein the phase out signals are generated by a calibration process applied to the quantum device.

Embodiment 3. The method as recited in any preceding embodiment, wherein the DAG comprises a coupling map of the quantum device indicating which pairs of qubits of the quantum device support two-qubit operations between them.

Embodiment 4. The method as recited in any preceding embodiment, wherein the ML model was trained using a dataset comprising samples obtained by executing quantum jobs, and the samples each comprise a pair [input tuple, output tuple].

Embodiment 5. The method as recited in any preceding embodiment, wherein the model input comprises an input tuple.

Embodiment 6. The method as recited in any preceding embodiment, wherein the phase-out signals are an element of an output tuple that further comprises: coherence times and measurement error rates of each of the qubits; and, an average gate error of the quantum device.

Embodiment 7. The method as recited in any preceding embodiment, wherein the phase-in control signals are automatically applied to the qubit lines after the quantum job is submitted to the quantum device.

Embodiment 8. A system, comprising hardware and/or software, operable to perform any of the operations, methods, or processes, or any portion of any of these, disclosed herein.

Embodiment 9. A non-transitory storage medium having stored therein instructions that are executable by one or more hardware processors to perform operations comprising the operations of any one or more of embodiments 1-7.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

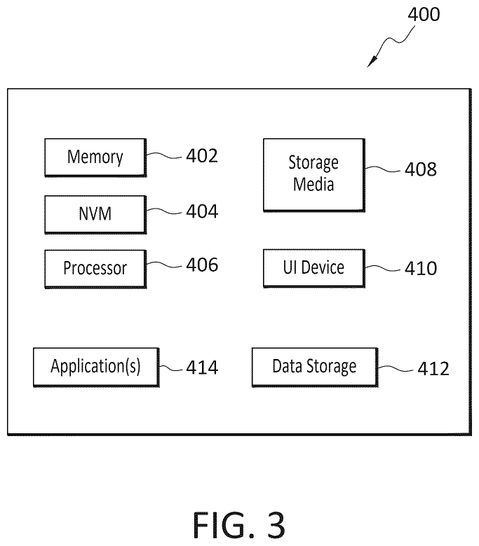

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
for a quantum job that has been submitted to a quantum device, running a background process comprising applying a respective phase-in control signal to each qubit line of the quantum device;
reading respective phase-out signals at an output of each of the qubit lines;
concatenating the phase-in signals with a directed acyclic graph (DAG) of the quantum device to create a model input; and
providing the model input to a ML (machine learning) model and obtaining, from the ML model, an estimate of a noise characteristic of the quantum device while the quantum job is executing on the quantum device.

2. The method as recited in claim 1, wherein the phase out signals are generated by a calibration process applied to the quantum device.

3. The method as recited in claim 1, wherein the DAG comprises a coupling map of the quantum device indicating which pairs of qubits of the quantum device support two-qubit operations between them.

4. The method as recited in claim 1, wherein the ML model was trained using a dataset comprising samples obtained by executing quantum jobs, and the samples each comprise a pair [input tuple, output tuple].

5. The method as recited in claim 1, wherein the model input comprises an input tuple.

6. The method as recited in claim 1, wherein the phase-out signals are an element of an output tuple that further comprises: coherence times and measurement error rates of each of the qubits; and, an average gate error of the quantum device.

7. The method as recited in claim 1, wherein the phase-in control signals are automatically applied to the qubit lines after the quantum job is submitted to the quantum device.

8. A non-transitory storage medium having stored therein instructions that are executable by one or more hardware processors to perform operations comprising:
for a quantum job that has been submitted to a quantum device, running a background process comprising applying a respective phase-in control signal to each qubit line of the quantum device;
reading respective phase-out signals at an output of each of the qubit lines;
concatenating the phase-in signals with a directed acyclic graph (DAG) of the quantum device to create a model input; and
providing the model input to a ML (machine learning) model and obtaining, from the ML model, an estimate of a noise characteristic of the quantum device while the quantum job is executing on the quantum device.

9. The non-transitory storage medium as recited in claim 8, wherein the phase out signals are generated by a calibration process applied to the quantum device.

10. The non-transitory storage medium as recited in claim 8, wherein the DAG comprises a coupling map of the quantum device indicating which pairs of qubits of the quantum device support two-qubit operations between them.

11. The non-transitory storage medium as recited in claim 8, wherein the ML model was trained using a dataset comprising samples obtained by executing quantum jobs, and the samples each comprise a pair [input tuple, output tuple].

12. The non-transitory storage medium as recited in claim 8, wherein the model input comprises an input tuple.

13. The non-transitory storage medium as recited in claim 8, wherein the phase-out signals are an element of an output tuple that further comprises: coherence times and measurement error rates of each of the qubits; and, an average gate error of the quantum device.

14. The non-transitory storage medium as recited in claim 8, wherein the phase-in control signals are automatically applied to the qubit lines after the quantum job is submitted to the quantum device.

15. A system, comprising:
one or more hardware processors; and
a non-transitory storage medium having stored therein instructions that are executable by the one or more hardware processors to perform operations comprising:
for a quantum job that has been submitted to a quantum device, running a background process comprising applying a respective phase-in control signal to each qubit line of the quantum device;
reading respective phase-out signals at an output of each of the qubit lines;
concatenating the phase-in signals with a directed acyclic graph (DAG) of the quantum device to create a model input; and
providing the model input to a ML (machine learning) model and obtaining, from the ML model, an estimate of a noise characteristic of the quantum device while the quantum job is executing on the quantum device.

16. The system as recited in claim 15, wherein the phase out signals are generated by a calibration process applied to the quantum device.

17. The system as recited in claim 15, wherein the DAG comprises a coupling map of the quantum device indicating which pairs of qubits of the quantum device support two-qubit operations between them.

18. The system as recited in claim 15, wherein the ML model was trained using a dataset comprising samples obtained by executing quantum jobs, and the samples each comprise a pair [input tuple, output tuple].

19. The system as recited in claim 15, wherein the phase-out signals are an element of an output tuple that further comprises: coherence times and measurement error rates of each of the qubits; and, an average gate error of the quantum device.

20. The system as recited in claim 15, wherein the phase-in control signals are automatically applied to the qubit lines after the quantum job is submitted to the quantum device.
